(19) United States
(12) Patent Application Publication
(10) Pub. No.: US 2008/0011834 A1
(43) Pub. Date: Jan. 17, 2008

(54) JOB-SITE INSPECTOR COMMUNICATIONS AND PLAN STORAGE UNIT

(76) Inventors: Donald R. Kinkade, Bakersfield, CA (US); Andrew Mitchell Harris, Lakemont, GA (US)

Correspondence Address: MITCH HARRIS, LLC - GENERAL, P.O. BOX 515, LAKEMONT, GA, 30552-0515, US

(21) Appl. No.: 11/457,656

(22) Filed: Jul. 14, 2006

(51) Int. Cl. G06K 5/00

(52) U.S. Cl. 235/382

(57) ABSTRACT

A job-site inspector communications and plan storage unit facilitates job-site inspections in the construction industry. The unit provides a designated location for inspector communications and plan storage that protects the job-card and plans. The unit may include wireless or wired electronics communications to facilitate communications and/or indications that inspections have been completed. The plans may be stored in hard copy in a plan storage box or cylinder attached to the unit, or may be electronically stored for local viewing or printing. Security features may be included to restrict access to the plans and/or job-card via traditional, electronic keys or passwords/personal identification numbers (PINs). Further, additional compartments may be accessed conditioned upon the security feature, completion of inspection or status of inspection.

### BACKGROUND OF THE INVENTION

1. Field of the Invention

The present invention relates generally to the construction industry, and more specifically, to a plan storage and communications unit for facilitating job-site inspections.

2. Background of the Invention

In the construction industry, for both residential and commercial construction, multiple stages of inspection and sign-off are required for each construction location or “job-site”. Developers and contractors also may be managing several job-sites at the same time and multiple inspectors are typically required to visit each of the job-sites at various states in the construction process.

Typically, contractors contact the inspectors offices telephonically and arrange each inspection independently, although there are in some instances pre-planned schedules subject to change. When the inspector visits, a “job-card” is typically marked and the results of the inspection are noted thereon. The job-card is located near the job site, as is a copy of the approved plans with which the inspector is basing her or his inspection. The plans and job card are generally placed in an agreed-upon location, which is typically not the same. For example, rules often require that the job-card be visible from the access road or driveway, while the plans may be left in an agreed upon location such as a kitchen of a house, in order to protect the plans from rain or other environmental factors. The job-card is also generally subject to environment, and often the only protection afforded for the job card is often attachment under an eave or awning of a building.

The inspector may or may not arrive at the job-site while construction or development personnel are present, and when personnel are not present, arrangement must be made for access, i.e., the site must be left open or a key must be provided in advance to the inspector. Also, after the inspector leaves, any key must typically be either returned by or retained by the inspector.

Contractors and developers typically only discover the results of an inspection by either visiting the job-site and examining the job-card, or by contacting the inspector again via telephone or in-person. The process takes time from the inspectors routine as well as adding further tasks that the developers and/or contractors must perform.

There are often other visitors to building sites, and developers and contractors may or may not want them to have access to job-cards and plans, but may want to advertise their information to prospective home buyers and others. For such purposes, signs are often located adjacent to building sites naming the project and/or developer. In some instances the contractors provide their own signs, in particular for specialized services such as stonemasonry or well drilling.

Therefore it would be desirable to provide systems and devices for further facilitating communication between inspectors and construction/development personnel, provide for a designated location for a job-cards and plans, environmental protection and security for the job-cards and plans, as well as potential advertising and provision of contact and/or project information.

### SUMMARY OF THE INVENTION

The above stated objectives of facilitating communication between inspectors and construction/development personnel, providing a designated location for job-cards and plans while providing environmental protection therefor, along with potential advertising/contact information display are achieved in a communications and plan storage unit.

In one embodiment, the unit includes a frame for securing the unit at the job-site, a plan storage container for storing and protecting construction plans and a job-card container for storing a job-card, while providing visibility for the job-card. The frame may be adapted for mounting on the side of a building or have legs for securing the unit away from the building. Security may be provided via mechanical or electronic locks that provide access to the plan container and job-card via a key or passcode or personal identification number (PIN).

In another embodiment, a display unit may provide the job-card and/or construction plans as a graphical depiction under control of a computer program, with the graphical display and optional print-out provided by an integrated printer providing a hard-copy that serves as the job-card and/or plans. A graphical display may be included whether or not the plan storage container and/or job card container are included, and may provide other features such as access user interface and advertising/development project information.

In either of the above-described configurations, a wireless or wired connection may provide a network interface, such as a network interface to a centralized Internet server, for signaling events occurring at the job-site, such as inspector visits, completion of inspection, conformance approval and/or disapproval including identification of specific inspection points. The communications may be had with a server belonging to the contractor and/or developer, the inspecting authority, or both. The specific person accessing the unit may be identified from passcode, PIN, a specific traditional or electronic key used by the person or identification otherwise entered via an input device included in the unit.

The above-described objectives, features, and further advantages of the invention are described in more detail below, in conjunction with the accompanying drawings.

### BRIEF DESCRIPTION OF THE DRAWINGS

Details of the invention and the uses thereof will be understood by a person of skill in the art when reading the following description in conjunction with the accompanying drawings. Further objectives and advantages presented by the invention will be apparent in light of the following description and drawings, wherein like reference numerals indicate like components, and:

FIGS. 1A-1C are pictorial diagrams of job-site inspector communications and plan storage units in accordance with embodiments of the present invention.

FIG. 2 is a pictorial diagram of a plan storage and job-card display system in accordance with another embodiment of the present invention.

FIG. 3 is a block diagram of the system depicted in FIG. 2.

### DESCRIPTION OF ILLUSTRATIVE EMBODIMENT

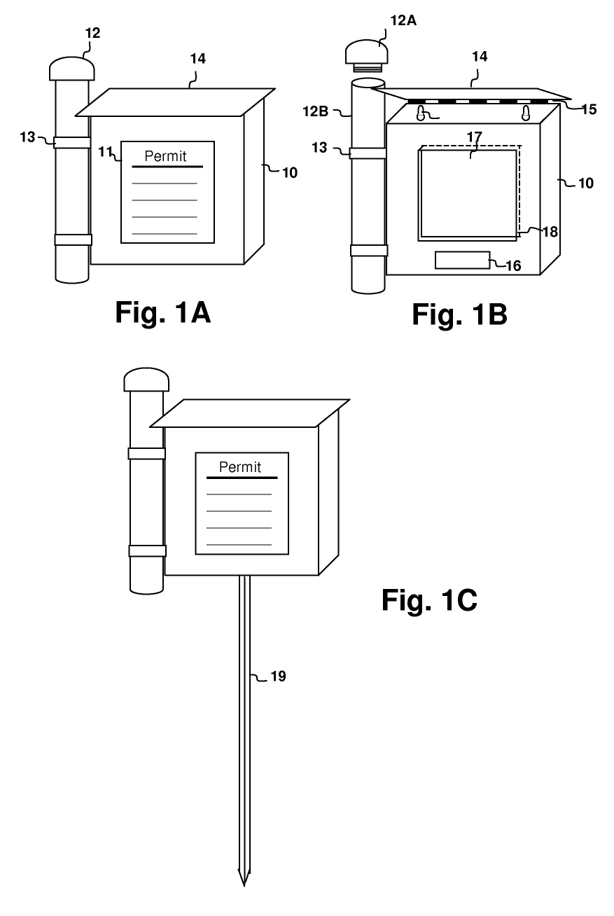

Referring now to the Figures, and in particular to FIG. 1A, a job-site inspector communications and plan storage unit in accordance with an embodiment of the present invention is depicted. Two major components of the unit, a plan storage container 12 in the form of a cylinder, and a job-card container 10 for storing a job-card are secured together by straps 13 and are provided with a mounting means for securing the unit at a job site. A transparent window 11 provides for visibility of the job card in jurisdictional locations where the job card must be displayed as a construction permit. A cover 14 provides access to job-card container 10 so that an inspector may leave notices and/or access the job card itself. While straps 13 are shown for attachment of plan storage container 12 to job-card container 10, other attachment mechanisms may be used, such as bolts, welded construction, or other suitable attachment techniques. Further, while plan storage container 12 is shown as a cylinder, other shapes may be employed, such as rectangular boxes of suitable depth.

Referring now to FIG. 1B, further details that may be incorporated within the unit depicted in FIG. 1A, or provided as an alternative, are shown. Plan container cylinder 12B has a removable top 12A, that may be a screw-type, stopper, cap or other top such as a hinged flip-lid, provides access to construction plan drawings and/or other documents to which an inspector needs access in order to perform a site inspection. Job-card container 10 includes a hinge 15 for securing cover 14, a transparent plastic panel 17, and a job-card holding frame 18 that retains the job-card proximate to panel 17. A business card holder or tag 16 provides a place for displaying contact information to the inspector and others, and will generally hold the developer's or contractor's information.

Mounting of the unit at a job site is accomplished in the embodiments depicted in FIGS. 1A and 1B by providing hangar holes 19A or other suitable mechanism to secure job-card container 10 to a wall of a building, temporary power-drop utility board, or other suitable agreed-upon location at a job site. FIG. 1C illustrates an alternative mounting means that employs a stake 19B that can be inserted in the ground to place the unit in, for example, the front yard of a residential construction site.

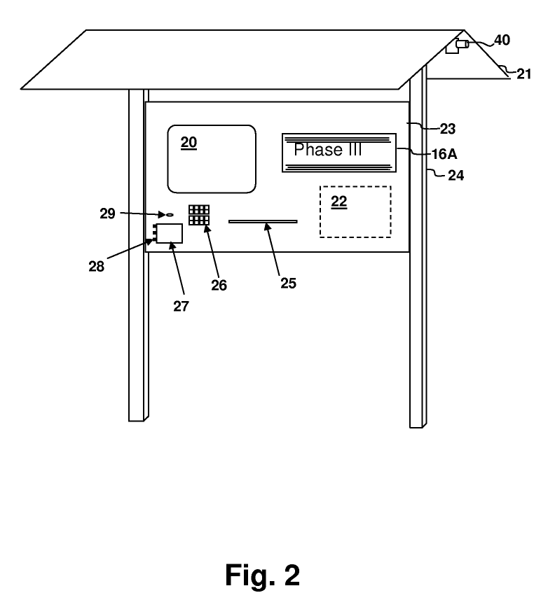

Referring now to FIG. 2, a job-site inspector communications and plan storage unit in accordance with another embodiment of the present invention is depicted. The depicted embodiment is a kiosk that includes electronic features that facilitate the inspection process. The system integrated into the kiosk is protected from the environment by a roof 21 and supported by legs 24.

A graphical display, such as a liquid crystal display (LCD) 20 is mounted on a backing frame member 23 and provides for graphical output of a simulated job-card and optionally construction plans that can be displayed to and interacted with by inspectors. A simulated job-card will generally include inspection points list and fields for the inspector to check off inspection status and note corrective action needs via an input device such as a keypad 26 or a touch-screen integrated with graphical display 20. Access to the kiosk can be regulated by requiring a hardware token such as a metal key for operating a keyswitch, a kensington or universal serial bus (USB) key (e.g., a USB device storing a digital certificate), that is inserted into a key slot 29, or a soft token such as a password or personal identification number (PIN) entered via keypad 26. If a storage-based key such as a USB device is employed, files such as plans and copies of the “virtual” job-card may be transferred to the key device for retention by the inspector.

Access to the kiosk via keypad entry or key insertion can be made to cause transmission of an indication of such activity to a remote server and the server may belong to the contractor/developer, inspection authority, or a third-party service provider. A visit by an inspector, developer employee or other person can thereby be uniquely identified. A camera 40 may be integrated with the kiosk to provide site monitoring for security or to verify the presence of an inspector or other person. Identification of the developer or contractor business is provided with a signage area 16A, which may be a holder for removable signs similar to that of business card holder or tag 16 of FIG. 1B, but will generally be larger attention-getting signage affixed to backing frame member 23. A wireless connection such as a wireless local-area network (WLAN) connection may be employed for communications with a computer system integrated within the kiosk, as such interfaces are increasingly available in metropolitan areas. Alternatively, a wired connection such as an analog telephone or digital subscriber link (DSL) line can be used with an internal modem to provide a network interface to the kiosk.

A printer 25 may be provided within kiosk to provide hard-copy of the “virtual” job-card information, inspection points lists, construction plans, advertising/sales information or other information as needed. A lockbox 27 may be provided with electronic access provided under computer control so that keys or other items may be exchanged with inspectors or other personnel under control of a key or electronic access code. Hinges 28 provide for opening and retaining lockbox 27 door.

Optionally a job card holder 22 similar to that depicted in the embodiments of FIGS. 1A-1C may be included on backing frame member 23, which may be used in jurisdictions that require posting of a permit/job-card in a visible location. A plan container such as those shown in FIGS. 1A-1C may also be mounted to frame member 23 and may be provided with manual or electronic lock mechanisms similar to lockbox 27 for applications where electronic display and/or printing of construction plans is not acceptable or in embodiments that do not include display 20 and/or printer 25, but do include computer controlled access and/or notification via wireless or wired communications.

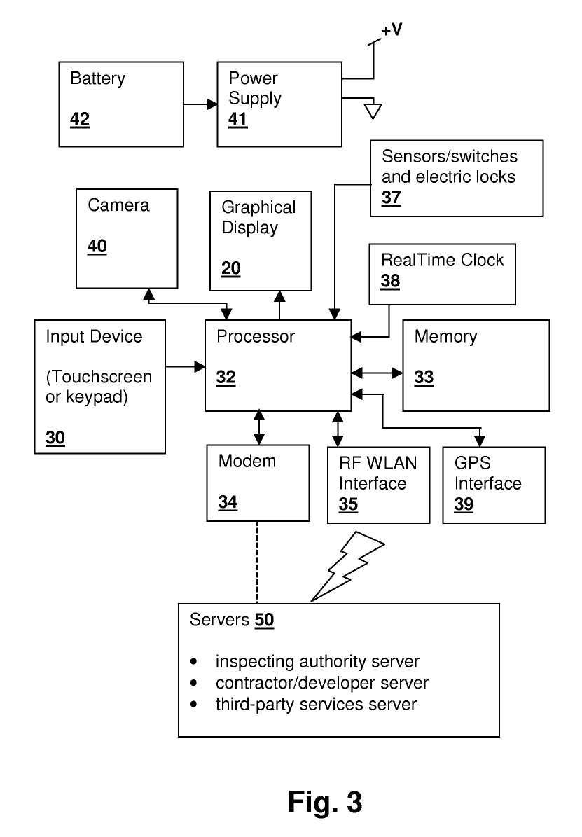

Referring now to FIG. 3, details of the computer system integrated within the kiosk of FIG. 2 are depicted. A processor 32 executes program instructions stored in a memory 33 that carry out operations required to provide the various visual displays, communications and other operations as described above. Camera 40 provides visual input, and may include pan/tilt and zoom controls that are remotely operable or move automatically under control of processor 32 to survey the are of the job-site. Graphical display 20 provides the output and input device 30 (which may be a touch-screen or keypad) provide the input of a graphical user interface implemented by program instructions in memory 33 for simulating a job-card, display of construction plans or their elements and other information such as informative and/or interactive displays for attracting buyers. A real-time clock 38 provides timing for events such as access via input device 30, key access, camera 40 image synchronization and the like. A set of sensors, switches and electronic locks 37 are coupled to processor 32 that may include electronic key slots, solenoid locks for locker 28 or plan containers 12.

An optional GPS interface 39 can be included to provide functions such as auto-location of a job-site to which the kiosk has been moved and to provide navigation information that may be provided to an inspector or other service provider about the location of the job-site. A modem 34 and/or RF WLAN interface 35 provide a means for the kiosk system to communicate with Internet servers 50 or other non-Internet machines. Servers 50 may include one or more of: 1) a server maintained by the inspecting authority; 2) a server maintained by the contractor/developer; and 3) a server maintained by a third party service provider that provides services in conjunction with the kiosk output or input. The communications possible with the kiosk system include, but are not limited to: 1) notifications that an access has been made via key or password/PIN, including identification of the unique holder of the token; 2) download to the kiosk of new files such as promotional displays, plans or updated job-card information; 3) upload from the kiosk of job-card modifications made by an inspector; 4) notifications that a plan container or locker have been accessed; 5) camera output in still or video data form; and 6) GPS location information. A power supply 41 and/or battery 42, which may also include a solar panel and charger provide power to the kiosk system. Power supply 41 will generally be of a 110 Vrms AC line drop for connection to a temporary power drop.

While the description above illustrates the use of a single kiosk at a single job-site, a kiosk can be centrally located or located at a particular job-site when multiple job-sites are nearby, and the individual plans and job-cards accessed by a site code. The centralized arrangement reduces the cost associated with having a kiosk per job-site and may provide some increased convenience for access by personnel who do not have to visit a particular job-site in order to accomplish a kiosk-centered task or want sales information.

The description provided above constitutes a description of the preferred embodiments of the invention, but the invention is not limited to the particular implementations shown or described. Those skilled in the art, having seen the above description and accompanying drawings, will understand that changes in form, structure and other details, as well as the order of operation of any operative steps may be varied without departing from the spirit and scope of the invention.

What is claimed is:

1. A job-site inspection unit, comprising:
a frame for securing said unit at said job-site;
a drawing container affixed to said frame, for protecting construction plan drawings from environmental damage; and
a job-card container affixed to said frame for providing storage of a job-card and visibility of said job-card from an exterior of said job-site inspection unit.

2. The job-site inspection unit of claim 1, wherein said frame includes at least one post extending downward from said frame for securing said job-site inspection unit in the ground.

3. The job-site inspection unit of claim 1, wherein said frame includes means for securing said frame to a side of a building at said job-site.

4. The job-site inspection unit of claim 1, further comprising a lock for securing access to at least one of said job-card container and said drawing container.

5. The job-site inspection unit of claim 1, wherein said job-card container includes a job-card holder including a transparent window for securing and displaying said job-card.

6. The job-site inspection unit of claim 1, further comprising:
an electronic circuit for receiving an indication of access to at least one of said job-card container and said drawing container; and
an interface circuit for communicating a result of said indication to a location remote from said job-site.

7. The job-site inspection unit of claim 6, wherein said interface circuit is a telephone line interface.

8. The job-site inspection unit of claim 6, wherein said interface circuit is a wireless communications transmitter.

9. A job-site inspection unit, comprising:
a frame for securing said unit at a location proximate to said job-site;
a graphical display device secured to said frame;
an input device secured to said frame; and
a processing system including a processor for executing program instructions and a memory for storing program instructions and data, wherein said program instructions comprise program instructions for simulating a job-card by displaying inspection data on said graphical display, and receiving user input from said input device to modify a status of said inspection data.

10. The job-site inspection unit of claim 9, further comprising an interface circuit for communicating an indication of said modified status of said inspection data to a location remote from said job-site.

11. The job-site inspection unit of claim 10, wherein said interface circuit is a wireless communications transmitter.

12. The job-site inspection unit of claim 10, wherein said interface circuit is a telephone line interface.

13. The job-site inspection unit of claim 10, wherein said interface circuit further communicates an indication of one of an identity and inspector type of an inspector providing said user input.

14. The job-site inspection unit of claim 9, further comprising a printer secured to said frame for providing hard-copy output of at least one of said inspection data, job card and a construction plan drawing.

15. The job-site inspection unit of claim 9, wherein said program instructions comprise program instructions for:
receiving a user input selecting among one of multiple job-sites for inspection as a selected job-site; and
responsive to said user input, simulating a job-card for said selected job-site.

16. The job-site inspection unit of claim 15, further comprising, responsive to said user input, providing construction drawing information associated with said selected job-site.

17. The job-site inspection unit of claim 9, further comprising a camera coupled to said processing system whereby one or more images proximate to said job-site can be captured in said memory.

18. The job-site inspection unit of claim 17, further comprising an interface circuit for communicating said one or more image to a location remote from said job-site.

19. The job-site inspection unit of claim 9, further comprising an electronically accessible lock box unit coupled to said processing system, wherein said processing system provides access to said lock box in response to one of an access code or electronic key insertion.

20. A method of facilitating construction job site inspections, comprising:
receiving an access token from an inspector;
providing access to at least one of construction plan drawings and a job card in response to receiving said access token; and
transmitting an indication that said access token has been received to a remote location.
